(19) United States
(12) Patent Application Publication
(10) Pub. No.: US 2026/0086201 A1
(43) Pub. Date: Mar. 26, 2026

(54) HIGH DENSITY LIDAR SYSTEMS

(71) Applicant: Seyond, Inc., Sunnyvale, CA (US)

(72) Inventors: Junwei Bao, Los Altos, CA (US); Yimin Li, Cupertino, CA (US)

(73) Assignee: Seyond, Inc., Sunnyvale, CA (US)

(21) Appl. No.: 19/408,093

(22) Filed: Dec. 3, 2025

Related U.S. Application Data
(63) Continuation of application No. 18/970,394, filed on Dec. 5, 2024.
Application No. 18/970,394 is a continuation of application No. 17/958,308, filed on Sep. 30, 2022, now Pat. No. 12,189,058.
Application No. 17/958,308 is a continuation of application No. 16/209,697, filed on Dec. 4, 2018, now Pat. No. 11,493,601.
(60) Provisional application No. 62/609,722, filed on Dec. 22, 2017.

(51) Int. Cl. G01S 7/481; G01S 17/89; G01S 17/931; G02B 26/10; G02B 26/12

(52) U.S. Cl. CPC G01S 7/4811; G01S 7/4817; G01S 17/89; G01S 17/931; G02B 26/101; G02B 26/123

(57) ABSTRACT

The present disclosure describes a system and method for LiDAR scanning. The system includes a light source configured to generate one or more light beams; and a beam steering apparatus optically coupled to the light source. The beam steering apparatus includes a first rotatable mirror and a second rotatable mirror. The first rotatable mirror and the second rotatable mirror, when moving with respect to each other, are configured to: steer the one or more light beams both vertically and horizontally to illuminate an object within a field-of-view; redirect one or more returning light pulses generated based on the illumination of the object; and a receiving optical system configured to receive the redirected returning light pulses.

### CROSS-REFERENCE TO RELATED APPLICATIONS

This application claims priority to U.S. provisional patent application No. 62/609,722, entitled “HIGH DENSITY LIDAR SCANNING,” filed on Dec. 22, 2017, the content of which is hereby incorporated by reference in its entirety for all purposes.

### FIELD OF THE DISCLOSURE

The present disclosure generally relates to light detection and ranging (LiDAR) systems and, more specifically, to systems for providing high density LiDAR scanning of objects in a field-of-view.

### BACKGROUND OF THE DISCLOSURE

A LiDAR system transmits light pulses to illuminate objects in a field-of-view and collect returning light pulses. Based on the returning light pulses, the LiDAR system calculates the time-of-flight and in turn determines the distance of a particular object. Typically, not all returning light pulses are collected by a LiDAR system due to the limited aperture for collecting the returning light pulses.

### SUMMARY OF THE DISCLOSURE

The following presents a simplified summary of one or more examples in order to provide a basic understanding of the disclosure. This summary is not an extensive overview of all contemplated examples, and is not intended to either identify key or critical elements of all examples or delineate the scope of any or all examples. Its purpose is to present some concepts of one or more examples in a simplified form as a prelude to the more detailed description that is presented below.

In accordance with some embodiments, a light detection and ranging (LiDAR) scanning system is provided. The system includes a light source configured to generate one or more light beams; and a beam steering apparatus optically coupled to the light source. The beam steering apparatus includes a first rotatable mirror and a second rotatable mirror. An axis that is perpendicular to a reflective surface of the first rotatable mirror is configured to be at a first angle to a first rotating axis of the first rotatable mirror, and an axis that is perpendicular to a reflective surface of the second rotatable mirror is configured to be at a second angle to a second rotating axis of the second rotatable mirror. At least one of the first angle or the second angle is greater than zero degree and less than 90 degree. The first rotatable mirror and the second rotatable mirror, when moving with respect to each other, are configured to: steer the one or more light beams both vertically and horizontally to illuminate an object within a field-of-view; redirect one or more returning light pulses generated based on the illumination of the object; and a receiving optical system configured to receive the redirected returning light pulses.

In accordance with some embodiments, a scanning system that is disposed with a vehicle is provided. The system includes a first light detection and ranging (LiDAR) scanning system disposed approximately at a front-left corner of the vehicle; a second LiDAR scanning system disposed approximately at a front-right corner of the vehicle; and a third LiDAR scanning system disposed approximately at a top portion of a front window-shield of the vehicle.

In accordance with some embodiments, a light detection and ranging (LiDAR) scanning system is provided. The system includes a light source configured to generate one or more light beams; and a beam steering apparatus optically coupled to the light source. The beam steering apparatus includes a first mirror and a rotatable mirror. The first mirror is an oscillation mirror or a Galvo mirror. An axis that is perpendicular to a reflective surface of the first mirror is configured to be at a first angle to an oscillation axis of the first mirror, and an axis that is perpendicular to a reflective surface of the rotatable mirror is configured to be at a second angle to a second rotating axis of the second rotatable mirror. At least one of the first angle or the second angle is greater than zero degree and less than 90 degree. The first mirror and the rotatable mirror, when moving with respect to each other, are configured to: steer the one or more light beams both vertically and horizontally to illuminate an object within a field-of-view; redirect one or more returning light pulses generated based on the illumination of the object; and a receiving optical system configured to receive the redirected returning light pulses.

### BRIEF DESCRIPTION OF THE DRAWINGS

For a better understanding of the various described aspects, reference should be made to the description below, in conjunction with the following figures in which like-referenced numerals refer to corresponding parts throughout the figures.

FIG. 1 illustrates an exemplary LiDAR scanning system that includes a beam steering apparatus having two rotatable mirrors.

FIG. 2A illustrates a diagram of exemplary scanning results of an exemplary LiDAR system that includes a beam steering apparatus having two rotatable mirrors.

FIG. 2B illustrates a diagram of a single frame of the exemplary scanning results of an exemplary LiDAR system that includes a beam steering apparatus having two rotatable mirrors.

FIG. 2C illustrates an exemplary LiDAR scanning system that includes a light source that transmits light beams at an angle based on scanning range requirements.

FIGS. 3A-3C illustrates an exemplary configurations of a light source.

FIG. 4A illustrates exemplary scanning results of an exemplary LiDAR scanning system that includes a light source having multiple light emitting devices.

FIG. 4B illustrates a single frame of the exemplary scanning results of an exemplary LiDAR scanning system that includes a light source having multiple light emitting devices.

FIG. 5 illustrates a circuit diagram of an exemplary driver circuit configured to provide electrical power to a light source of the LiDAR scanning system.

FIG. 6 illustrates a typical configuration of multiple LiDAR systems attached to a vehicle.

FIG. 7 illustrates an exemplary configuration of multiple LiDAR systems attached to a vehicle.

FIG. 8 illustrates an exemplary flow chart for a method of determining time of flight of one or more light pulses, according to examples of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Examples of LiDAR scanning systems will now be presented with reference to various elements of apparatus and methods. These apparatus and methods will be described in the following detailed description and illustrated in the accompanying drawing by various blocks, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

A typical LiDAR scanning system has limited apertures for collecting returning light pulses. Increasing the apertures are thus desired. The various configuration of LiDAR systems described in this application can increase the aperture for collecting returning light pulses. In turn, the increased aperture improves the scanning range in both horizontal and vertical scanning directions, and therefore enables detecting more objects in the field-of-view. In addition, the various configuration of LiDAR systems described in this application can also provide overlapping scanning results in a pre-determined scanning range (e.g., short distances from the vehicle in both horizontal and vertical directions). The overlapping scanning results obtained for the pre-determined scanning range can thus provide a high density scanning, resulting in a high-resolution image. Moreover, various configuration of disposing multiple LiDAR systems in a vehicle can reduce or eliminate possible scanning gaps where objects in the field-of-view may not be detected. This in turn reduces or eliminates the likelihood that a vehicle collide with the undetected objects.

Although the examples of the disclosure are described for integration in a vehicle, other applications are contemplated. For example, a centralized laser delivery system and multiple LiDAR systems can be disposed in or integrated with robots, installed at multiple locations of a building for security monitoring purposes, or installed at traffic intersections or certain location of roads for traffic monitoring, etc.

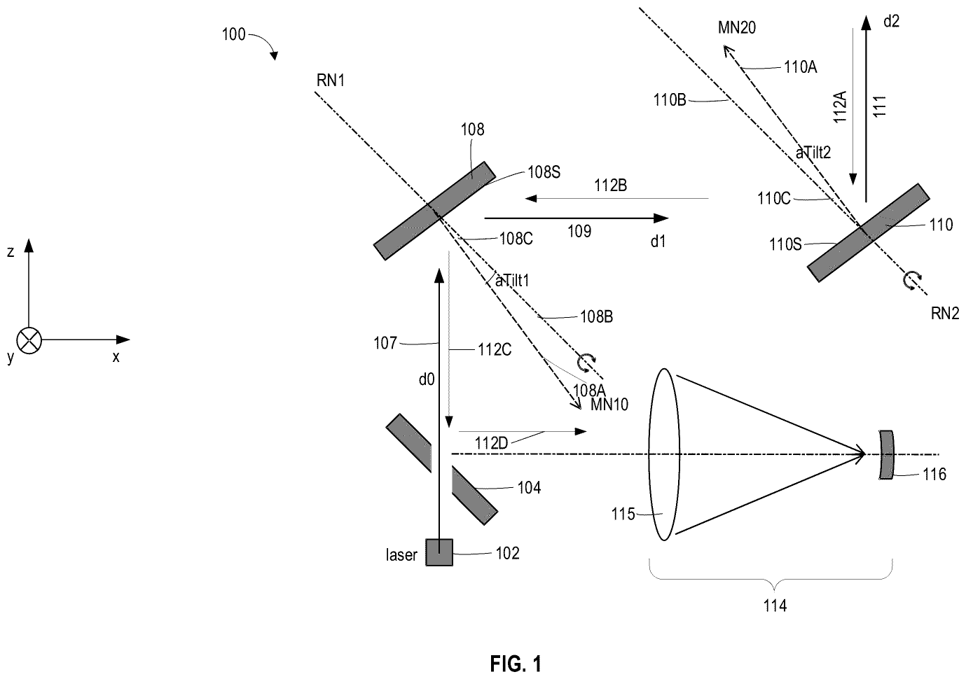

FIG. 1 illustrates an exemplary LiDAR scanning system 100 that includes a beam steering apparatus having two rotatable mirrors 108 and 110. LiDAR scanning system 100 can be 2D or 3D scanning LiDAR system. In some embodiments, LiDAR scanning system 100 includes a light source 102, an optical element 104, a first rotatable mirror 108, a second rotatable mirror 110, and a receiving optical system 114. As illustrated in FIG. 1, first rotatable mirror 108 and second rotatable mirror 110, when moving with respect to each other, can be configured to steer one or more light beams 107 both vertically and horizontally to illuminate one or more objects within the field-of-view of LiDAR scanning system 100, and redirect one or more returning light pulses generated based on the illumination of the objects. Light source 102 can generate one or more light beams 107 that include incident light pulses. Light source 102 can be a laser light source such as a fiber laser, a diode laser, a diode pump solid state laser, and/or a fiber coupled diode laser. In some examples, the laser light generated by light source 102 can have a wavelength in the visible spectrum. In some examples, the laser light can have a wavelength in the infrared spectrum. In some examples, the laser light can have a wavelength in the ultra violet spectrum.

As illustrated in FIG. 1, one or more light beams 107 that include incident light pulses are transmitted toward first rotatable mirror 108 via an optical element 104. In some embodiments, optical element 104 can include a lens and/or an opening for focusing and/or directing light beams 107 to first rotatable mirror 108. In some embodiments, first rotatable mirror 108 can redirect the incident light pulses of light beams 107 toward second rotatable mirror 110. As illustrated in FIG. 1, first rotatable mirror 108 can generate redirected light pulses 109 based on incident light pulses of light beams 107. First rotatable mirror 108 can be configured to rotate along a first rotating axis 108B at a speed of, for example, 199 r/s (revolutions per second).

In some embodiments, to scan the outgoing light pulses and collect the returning light pulses across different horizontal and vertical angles in the field of view, first rotating axis 108B is not, or does not overlap with, the axis that is perpendicular to a reflective surface (e.g., surface 108S) of the first rotatable mirror 108 (e.g., the nominal axis 108A of first rotatable mirror 108). For example, as illustrated in FIG. 1, first rotating axis 108B can be configured to be at a first angle 108C with axis 108A, which is the axis that is perpendicular to reflective surface 108S of the first rotatable mirror 108. In some examples, first angle 108A is an angle that is greater than 0 degrees and less than 90 degrees. For instance, first angle 108A can be 10 degrees. As described in more detail below, configuring first rotating mirror 108 to rotate along first rotating axis 108B that is not the mirror's nominal axis can scan the transmitting/redirecting light pulses to the objects at different horizontal and vertical angles in the field of view, and for receiving and redirecting the corresponding returning light pulses (e.g., light pulses 112B).

With reference to FIG. 1, first rotatable mirror 108 can be configured to redirect incident light pulses of one or more light beams 107 toward second rotatable mirror 110. As illustrated in FIG. 1, based on the incident light pulses of light beams 107, first rotatable mirror 108B generates redirected light pulses 109. Redirected light pulses 109 are received by second rotatable mirror 110. In some embodiments, second rotatable mirror 110 can be configured to rotate along a second rotating axis 110B. In some examples, second rotatable mirror 110 can be configured to rotate at a speed that is different from the rotation speed of the first rotatable mirror 108. For example, the first rotatable mirror 108 can rotate at 199 r/s and the second rotatable mirror 110 can rotate at 189 r/s.

In some embodiments, to scan the transmitting light beam 111 at different horizontal and vertical angles in the field of view, second rotating axis 110B is not, or does not overlap with, the axis that is perpendicular to a reflective surface (e.g., surface 110S) of the second rotatable mirror 110 (e.g., the nominal axis 110A of second rotatable mirror 110). For example, as illustrated in FIG. 1, second rotating axis 110B can be configured to be at a second angle 110C with axis 110A, which is the axis that is perpendicular to a reflective surface 110S of the second rotatable mirror 110. In some embodiments, second angle 110C is an angle that is greater than 0 degrees and less than 90 degrees. For example, second angle 110C can be 8 degrees. Second angle 110C can be the same or different from first angle 108C (e.g., first angle 108C is 10 degrees, and second angle 110C is 8 degrees). As described in more detail below, configuring the second rotating mirror 110 to rotate along second rotating axis 110B that is not the nominal axis can scan the transmitting/redirecting light pulses to the objects at different horizontal and vertical angles in the Field of View (“FOV”), and for receiving and redirecting the corresponding returning light pulses (e.g., light pulses 112A).

In some embodiments, both first angle 108C and second angle 110C can be different from 90 degrees (e.g., greater than 0 degree and less than 90 degree). That is, both first rotatable mirror 108 and second rotatable mirror 110 are rotated at an angle with respect to their respective nominal axes (e.g., axes 108A and 110A). Configuring the mirrors in this manner can scan the transmitting/redirecting light pulses to the objects at different horizontal and vertical angles in the field of view and thus increase the scanning range and density of LiDAR scanning system 100.

With reference to FIG. 1, second rotatable mirror 110 receives redirected light pulses 109 from first rotatable mirror 108, and generates and transmits steered light pulses 111 in both the horizontal and vertical directions to illuminate objects in the FOV. It is appreciated that the direction of steered light pulses 111 shown in FIG. 1 only illustrates the direction at a particular point of time. In other points in time, steered light pulses 111 can be transmitted in other directions to illuminate objects in the FOV.

In some embodiments, first rotatable mirror 108 and second rotatable mirror 110 can be near 100% reflective mirrors that are disposed along the optical path for collecting returning light pulses 112A (and redirected returning light pulses 112B-C). As illustrated in FIG. 1, one or more steered light pulses 111 illuminate one or more objects in the FOV and are reflected or scattered. Some of the reflected or scattered light pulses return to second rotatable mirror 110 as returning light pulses 112A. Second rotatable mirror 110 redirects returning light pulses 112A to generate redirected returning light pulses 112B in a substantially reverse direction of redirected light pulses 109. As described above, second rotatable mirror 110 can be configured to rotate about second rotating axis 110B that is at second angle 110C (e.g., an 8-degree angle) to the mirror's nominal axis 110A.

As shown in FIG. 1, first rotatable mirror 108 redirects redirected returning light pulses 112B to generate second redirected returning light pulses 112C. In some embodiments, as described above, first rotatable mirror 108 can be configured to rotate along first rotating axis 108B that is at first angle 108C (e.g., a 10-degree angle) to the mirror's nominal axis 108A. As a result, first rotatable mirror 108 can be configured to direct second redirected returning light pulses 112C toward the optical element 104, which in turn generates third redirected returning light pulses 112D that are collected by the receiving optical system 114. Receiving optical system 114 can include, for example, a converging lens 115 and a light detector 116. Light detector 116 can include one or more light detector elements. Converging lens 115 is configured to collect and direct second redirected returning light pulses 112C to light detector 116. The converging lens 115 can be made from any transparent material such as high index glass, plastic, or the like. FIG. 1 illustrates an exemplary position that receiving optical system 114 may be disposed. It is appreciated that receiving optical system 114 can be disposed at any desired position to effectively collect a substantial portion of third redirected returning light pulses 112D.

In some embodiments, receiving optical system 114 can include a light detector 116 that includes an array of light detector elements. For example, light detector 116 can include an array of 16 detector elements for detecting light pulses collected by converging lens 115. The number of detector elements in the array can be the same as or different from the number of light emitting devices (e.g., devices 302A-D and 304A-D described in more detail below) in light source 102. For example, the number of detector elements can be 16 and the number of light emitting devices can be 4. The higher number of detector elements can increase the resolution of the LiDAR scanning results.

In some embodiments, one of the first rotatable mirror 108 and second rotatable mirror 110 can be replaced with an oscillation mirror or a Galvo mirror. An oscillation mirror can oscillate about an axis at a predetermined frequency or rate. Similar to a rotatable mirror, the oscillation mirror can redirect light pulses to illuminate the objects in the FOV and collect and redirect returning light pulses to the receiving optical system and light detector. In some embodiments, the oscillation frequency or rate of an oscillation mirror can be configured based on the scanning range requirement and/or the scanning density requirement.

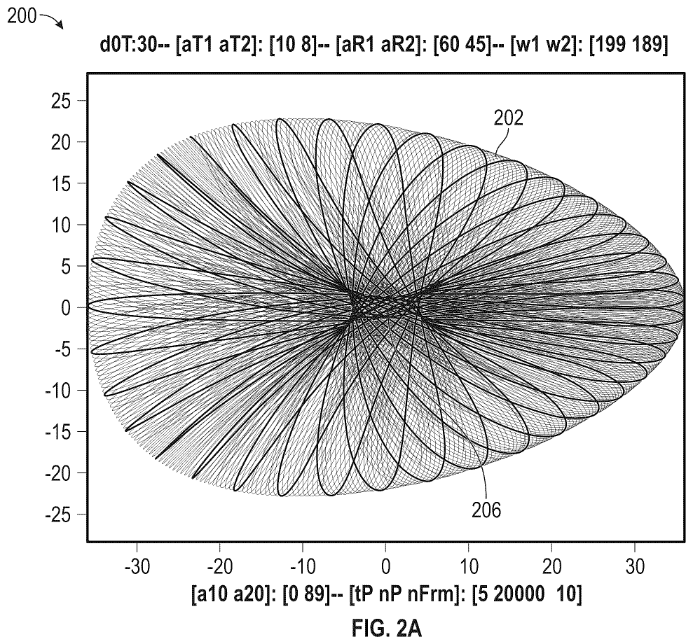

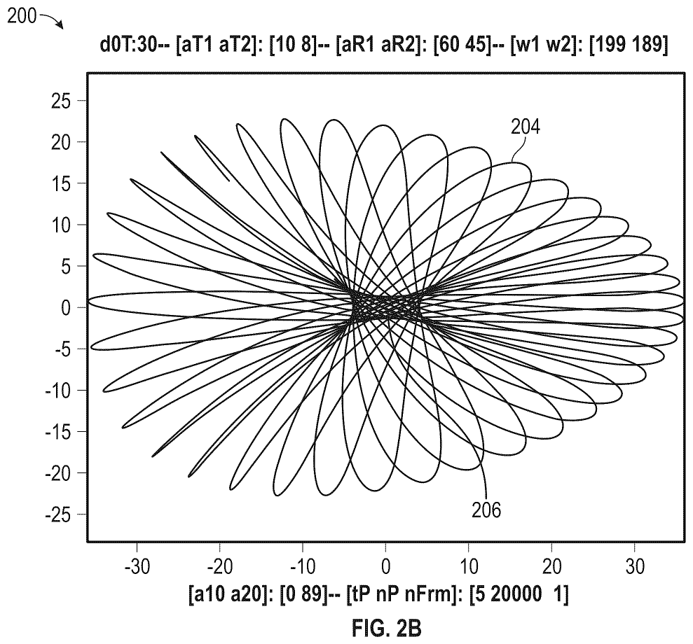

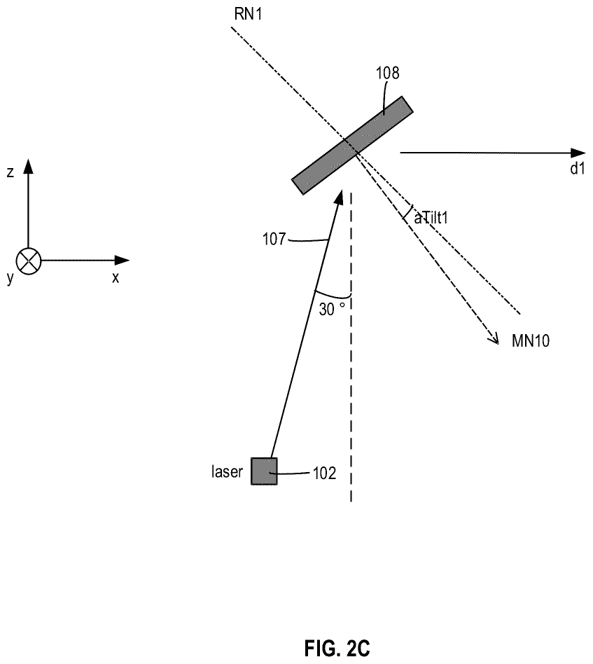

FIG. 2A illustrates a diagram 200 of exemplary scanning results of an exemplary LiDAR system 100 that includes a beam steering apparatus having two rotatable mirrors (e.g., mirrors 108 and 110). FIG. 2B illustrates a diagram of a single frame of the exemplary scanning results shown in FIG. 2A. The scanning results illustrated in FIG. 2A represent scanning patterns 202 of multiple frames collected/integrated over a predetermined period of time (e.g., 1 second or 10 seconds); and the scanning result illustrated in FIG. 2B represents the scanning patterns 204 of a single frame (e.g., collected over 0.1 second). In FIGS. 2A and 2B, the horizontal axis indicates the scanning range in the horizontal scanning direction (e.g., corresponding to the x direction shown in FIG. 1); and the vertical axis can indicate the scanning range in the vertical scanning direction (e.g., corresponding to the y direction shown in FIG. 1).

As shown in FIGS. 2A and 2B, the horizontal scanning range of this particular configuration of LiDAR scanning system 100 can be, for example, about −35 degree to 35 degree; and the vertical scanning range can be, for example, about −21 degree to 21 degree. As further shown in FIGS. 2A and 2B, in some embodiments, the center portion 206 of the scanning patterns 202 and 204 can have a higher density than other portions of the scanning patterns. The higher density of scanning is often desirable because it can provide a higher resolution LiDAR scanning. As described above, the higher scanning density in the center portion 206 is obtained as a result of configuring both first rotatable mirror 108 and second rotatable mirror 110 to rotate about a rotating axis (e.g., 108B and 110B) that does not overlap or align with the nominal axis of the respective mirror.

In some embodiments, one or more attributes of LiDAR scanning system 100 are customizable. For example, one or more attributes of LiDAR scanning system 100 can be configured to obtain desired scanning ranges and scanning density based on a scanning range requirement and/or a scanning density requirement. As one example, based on the scanning range and density requirements, first rotatable mirror 108 can be configured to rotate at a speed of 199 r/s; the first angle 108C (e.g., the angle between the first rotating axis 108B and nominal axis 108A) can be configured to be about 10 degrees; the second rotatable mirror 110 can be configured to rotate at a speed of 189 r/s; and the second angle 110C (e.g., the angle between the second rotating axis 110B and nominal axis 110A) can be configured to be about 8 degrees. Based on such configuration, the horizontal scanning range can be, for example, about −35 degree to 35 degree; the vertical scanning range can be, for example, about −21 degree to 21 degree; the high-density center portion 206 can have a horizontal scanning range of about 8 degrees and vertical scanning range of 3 degrees. As described above, high-density center portion 206 can correspond to a scanning area in the FOV that is predetermined to have more objects or has a heightened level of detection requirement (e.g., the nearby front area of a LiDAR scanning system mounted on a vehicle).

In some embodiments, having horizontal scanning range that is greater than the vertical scanning range is often desirable. For example, in an FOV, scanning more area across the horizontal direction (e.g., the x direction shown in FIG. 1 such as the direction that is parallel to the road surface) is often desirable than scanning more area across the vertical direction (e.g., the y direction shown in FIG. 1 such as the direction that is perpendicular to the road surface). This is because typically, more objects (e.g., human, building, animals, etc.) are disposed across the horizontal direction (e.g., on a road surface) than disposed across the vertical direction. Thus, for a LiDAR scanning system to be able to scan more area in the FOV, it is typically desirable to have a higher horizontal scanning range than a vertical scanning range.

In some embodiments, one or more attributes of first rotatable mirror 108 and second rotatable mirror 110 can be configured to be the same. In other embodiments, they can be configured to be different. For example, as illustrated in FIGS. 1, 2A and 2B, first angle 108C (e.g., 10 degrees) can be configured to be different from second angle 110C (e.g., 8 degrees); and the rotating speed of first rotatable mirror 108 (e.g., 199 r/s) can be configured to be different from rotating speed of second rotatable mirror 110 (e.g., 189 r/s). The rotating speed of a rotatable mirror can determine the distance between neighboring scanning lines. The rotating speed difference between the first rotatable mirror 108 and second rotatable mirror 110 can determine the rate of scanning (e.g., determine the scanning range in one second).

With reference to FIGS. 1 and 2A-2B, in some embodiments, light source 102 can be configured to generate the one or more light beams 107 at a frequency in accordance with the scanning density requirements associated with one or more scanning directions. For example, because the scanning density is a function of the spacing between two adjacent scanning lines and the spacing is a function of the scanning frequency, the frequency of the light beams 107 can be adjusted to obtain the desired scanning density at different portion of the scanning pattern. For instance, to obtain a higher scanning density in the center portion of the FOV than in the edge portions of the FOV, the scanning frequency of light source 102 can be configured to be higher when scanning the center portion of the FOV than when scanning the edge of the FOV. Further, in some embodiments, a scanning frequency of light source 102 can also be configured to be different from the scanning frequencies of other light sources in adjacent LiDAR scanning systems to avoid interference.

With reference to FIGS. 1 and 2A-2B, in some embodiments, light source 102 can be configured to transmit the or more light beams 107 at a direction in accordance with scanning range requirements of one or more scanning directions. For example, as shown in FIG. 1, light source 102 can be configured to transmit light beams 107 along the z direction (e.g., no tilt with respect to the z direction). As a result shown in FIGS. 2A and 2B, with this configuration, the scanning range in the vertical direction (e.g., the y direction) can be about −21 degrees to 21 degrees (i.e., total about 42 degrees) and the scanning range in the horizontal direction (e.g., the x direction) can be about −35 degrees to 35 degrees (i.e., total about 70 degrees).

With reference to FIG. 2C, in some embodiments, light source 102 can be configured to transmit light beams 107 at an angle to the z direction. The angle can be more than 0 degrees and less than 90 degrees. For instance, as described above, a wider scanning range in the horizontal direction is typically desirable and thus to further increase the horizontal scanning range (and reduce the vertical scanning range), light source 102 can be configured to transmit light beams 107 at about 30 degrees angle to the z direction (i.e., tilted with respect to the z direction).

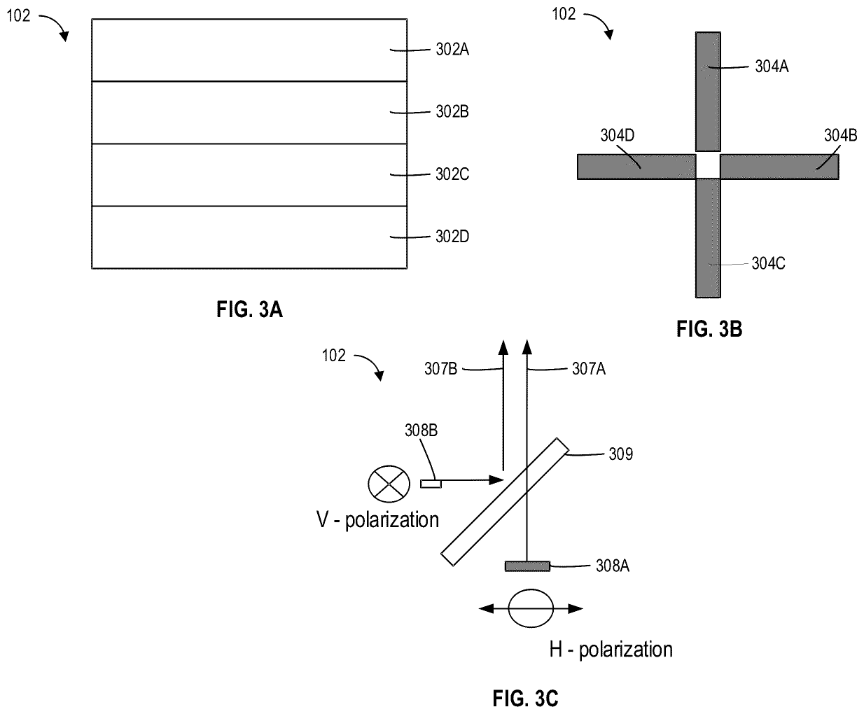

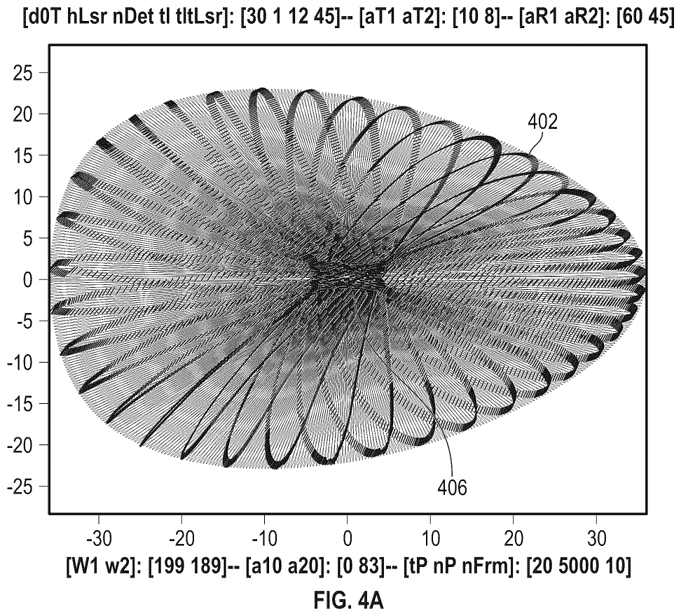

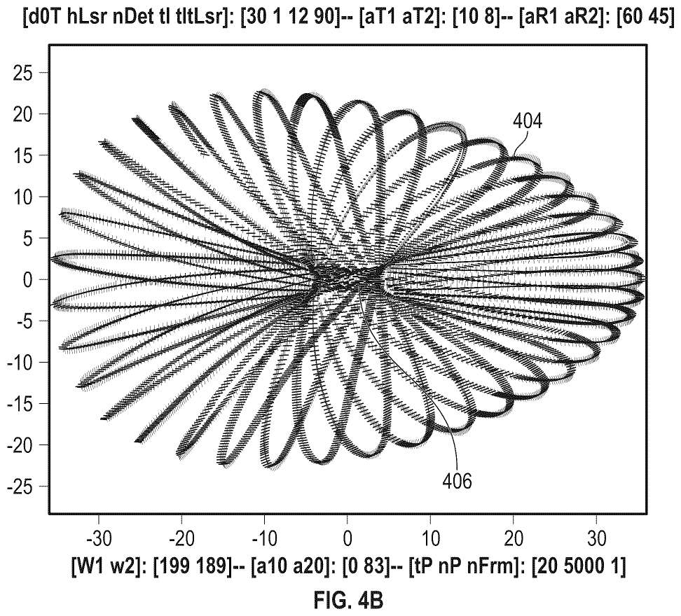

FIGS. 3A-3B illustrates exemplary configurations of a light source 102. In some embodiments, light source 102 can include a plurality of light emitting devices. Each of the light emitting devices can generate, for example, a laser beam. As shown in FIG. 3A, light source 102 can include a plurality of light emitting devices 302A-D forming a rectangular-shaped array. As another example shown in FIG. 3B, light source 102 can include a plurality of light emitting devices 304A-D having a cross-shape. In some embodiments, each of the light emitting devices 304A-D can include a plurality of light emitting elements. In some embodiments, the light detector 116 as shown in FIG. 1 can include a plurality of light detecting elements that are disposed in the same pattern or shape (e.g., a rectangular-shaped array or a cross-shape) as the light emitting devices. The number of the light emitting devices in a light source may or may not be the same as the number of the light detecting elements in a corresponding light detector. It is appreciated that light source 102 can include any number of light emitting devices forming any desired shapes based on the scanning range and scanning density requirements. For example, using 2-4 light emitting devices in a cross-shaped configuration, light source 102 can increase the scanning density in both the horizontal and vertical directions. FIGS. 4A-4B illustrate exemplary scanning results of LiDAR scanning system 100 that includes a light source 102 having multiple light emitting devices.

As shown in FIGS. 4A-4B, in some embodiments, using a plurality of light emitting devices can further increase the scanning density by generating multiple scanning points or lines in the scanning results. For example, the LiDAR scanning results shown in FIGS. 2A-2B are generated by a LiDAR scanning system having a light source with a single light emitting device. The LiDAR scanning results shown in FIGS. 4A-4B are generated by a LiDAR scanning system 100 having a light source with multiple (e.g., 4) light emitting devices (e.g., devices 304A-D). The LiDAR scanning results shown in FIGS. 2A-2B and 4A-4B are obtained using similar attributes of the rotatable mirrors (e.g., similar rotating speed, similar tilting angles, etc.). As shown in FIGS. 4A-4B, the scanning ranges of a system having multiple light emitting devices in both the horizontal and vertical directions are similar to a system having a single light emitting device; while the scanning density of the former system is higher than the latter system in both scanning directions. Moreover, using a system having multiple light emitting devices, the scanning density of the center portion 406 can also be further increased to provide a higher resolution scanning result.

With reference back to FIGS. 3A-3B, in some embodiments, each of the light emitting devices (e.g., devices 302A-D and 304A-D) can generate and transmit light beams independently from each other. Transmitting light beams from different light emitting devices independently allows multiple light detectors in a LiDAR scanning system to share an amplifier and analog-to-digital converter, thereby reducing the overall dimension of the LiDAR scanning system and also improving the efficiencies of the system. In some embodiments, a single light emitting device in a light source 102 can be configured to transmit an elongate light beam (e.g., from a diode laser), thus enabling a configuration of using one light emitting device for multiple light detectors. This further reduces the overall dimension of the LiDAR scanning system and improves the effective resolution and scanning density. It is appreciated that based on the resolution, scanning range, and scanning density requirements, LiDAR scanning system 100 can be configured to include any number of light emitting devices and any number of light detectors.

With references to FIG. 3C, in some embodiments, at least two of the plurality of light emitting devices can be configured to transmit light beams having different polarizations. For example, as shown in FIG. 3C, a light source 102 includes two light emitting devices 308A and 308B disposed at about 90 degree angle with respect to each other (e.g., as part of a cross-shaped configuration shown in FIG. 3B). Light emitting device 308A can be configured to transmit a light beam 307A having a horizontal polarization; and light emitting device 308B can be configured to transmit a light beam 307B having a vertical polarization. As shown in FIG. 3C, to direct both light beams 307A and 307B to a rotatable mirror (not shown in FIG. 3C), a polarization-sensitive device 309 can be disposed in the optical path of both light beams 307A and 307B. The polarization-sensitive device 309 allows horizontally-polarized light (parallel to the paper surface) to pass through; and reflects the vertically-polarized light (perpendicular to the paper surface) to a substantially 90 degree direction. Accordingly, light beams 307A and 307B can both be directed to a same direction.

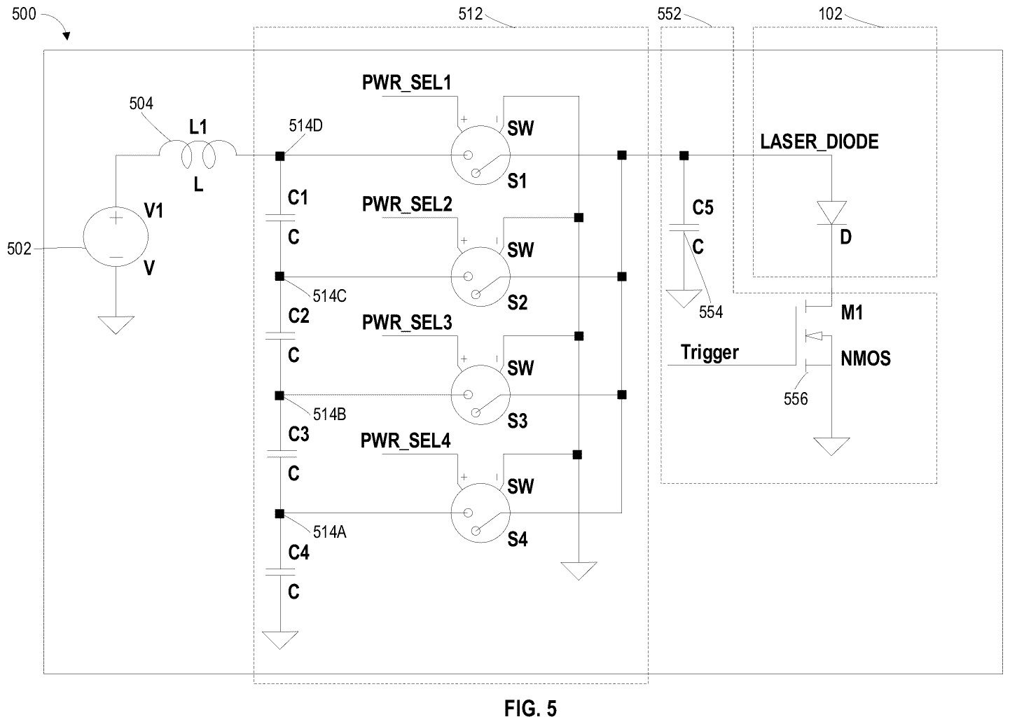

FIG. 5 illustrates a circuit diagram of an exemplary driver circuit 500 configured to provide electrical power to a light source of a LiDAR scanning system (e.g., system 100). As illustrated in FIG. 5, in some embodiments, driver circuit 500 can include an electrical power source 502, a current limiting device 504, a power controller 512, and a power delivery circuit 552. Driver circuit 500 is electrically coupled to light source 102. As shown in FIG. 5, light source 102 can include, for example, a light emitting device that generates light beams (e.g., a 905 nm laser beam).

With reference to FIG. 5, in some embodiments, electrical power source 502 can be a voltage source and/or a current source. Electrical power source 502 can be coupled to power controller 512 using an electrical wire and optionally current limiting device 504. Current limiting device 504 limits the electrical current to protect the components of driver circuit 500 from electrical overstress. Current limiting device 504 can be, for example, an inductor and/or a resistor.

With reference to FIG. 5, power controller 512 is configured to control a level of the electrical power to-be-delivered to light source 102. In some embodiments, power controller 512 includes a voltage divider circuit configured to generate a plurality of discrete voltage levels. As shown in FIG. 5, an exemplary voltage divider circuit include a plurality of capacitors C1-C4 coupled in a serial manner. For example, a first terminal of capacitor C1 is electrically coupled to the current limiting device 504; a second terminal of capacitor C1 is electrically coupled to a first terminal of capacitor C2; a second terminal of capacitor C2 is electrically coupled to a first terminal of capacitor C3; and so forth. The second terminal of capacitor C4 is electrically coupled to an electrical ground. The voltage divider as shown in FIG. 5 can provide an output voltage that is a fraction of its input voltage. For example, for a DC input voltage applied at coupling point 514D, the voltage divider can generate a plurality of discrete voltage levels at each coupling point 514A-C. Each of the discrete voltage levels can be a different fraction of the voltage at coupling point 514D depending on the capacitance of capacitors C1-C4. It is appreciated that the capacitance of capacitors C1-C4 can be configured in any desirable manner (e.g., the same or different), and the voltage divider circuit of power controller 512 can include any number of capacitors, resistors, inductors, or a combination of these electrical components. For example, in some embodiments, capacitors C1-C4 can be replaced with resistors R1-R4.

In some embodiments, power controller 512 can further include a plurality of switches configured to enable selection of the plurality of discrete voltage levels at coupling point 514A-514D. As shown in FIG. 5, in some embodiments, power controller 512 includes switch S1-S4 that are controllable by a plurality of control signals PWR_SEL1 to PWR_SEL4, respectively. For example, if the control signal PWR_SEL4 is enabled and other control signals are disabled, switch S4 can be closed and the voltage at coupling point 514A can be selected and coupled to power delivery circuit 552. And if the control signal PWR_SEL3 is enabled and other control signals are disabled, switch S3 can be closed and the voltage at coupling point 514B can be selected and coupled to power delivery circuit 552; and so forth. It is appreciated that the number of control signals can be configured corresponding to the number of discrete voltage levels in the voltage divider.

In some embodiments, the power controller 512 can be configured to control the level of the electrical power to-be-delivered to the light source 102 for each light pulse. For example, the power selection signal PWR_SEL4 can be enabled to close switch S4 for a first light pulse, and the power selection signal PWR_SEL3 can be enabled to close switch S3 for a second light pulse. As a result, different light pulses can have different power levels. In some embodiments, the controlling of power levels for light pulses can be based on the objects in the FOV. For example, the power levels of light pulses can be adjusted according to the distance and geometry of the objects in the FOV. The power levels can also be adjusted based on the prior received optical power at the light detector. For example, the adjusting of the power levels can be part of a feedback and/or feedforward control loop. If the prior received optical power is determined to be low, insufficient, or otherwise undesirable (e.g., the power level of the detected returning light pulses is low, which may indicate an object is located far away from the LiDAR scanning system or that the object is absorbing the transmitted light pulses at a high level), the power level can be increased for the next light pulse.

As shown in FIG. 5, power controller 512 can be electrically coupled to power delivery circuit 552. In some embodiments, power delivery circuit 552 includes a charge storage device 554 configured to store electrical charges corresponding to the level of the electrical power to-be-delivered to the light source 102. Charge storage device 554 can be, for example, a capacitor. Power delivery circuit 552 can also include a charge releasing device 556 configured to receive a trigger signal; and in response to receiving the trigger signal, deliver the stored electrical charges to the source 102. As shown in FIG. 5, power control signals PWR_SEL1-PWR_SEL4 controls the voltage level at the input terminal of charge storage device 554, which stores the charge over a period of time. For delivering the stored charge to light source 102 (e.g., a light emitting diode), a trigger signal can be enabled to turn on the charge releasing device 556. The trigger signal can be configured to turn on and off the charge releasing device 556 at a pre-determined rate or frequency such that one or more light pulses are generated from light source 102.

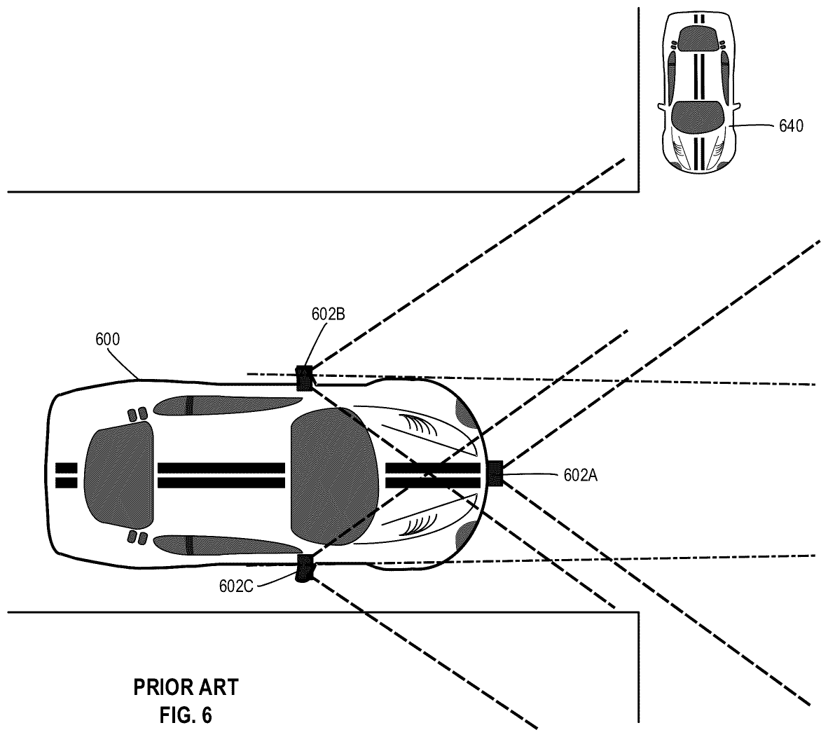

FIG. 6 illustrates a typical configuration of multiple LiDAR systems disposed with a vehicle 600. As shown in FIG. 6, for example, in a typical configuration, LiDAR system 602A is attached to vehicle 600 at the middle front; LiDAR system 602B is attached to vehicle 600 at the driver side rear-view mirror; and LiDAR system 602C is attached to vehicle 600 at the passenger side rear-view mirror. In this typical configuration, the FOV of the LIDAR systems 602A-C may have gap and thus the LiDAR systems may be unable to detect some objects in the surrounding environment of vehicle 600. As shown in FIG. 6, the FOV of LiDAR system 602A (indicated by the two lines extending from system 602A) may not be wide enough to detect a vehicle 640 that is approaching an intersection. While the FOV of LiDAR system 602B (indicated by the two lines extending from system 602B) may be able to cover the area of vehicle 640, the scanning light pulses from system 602B may be obstructed, for example, by a building at the intersection, such that vehicle 640 cannot be detected. As a result, there is a gap of scanning between system 602A and 602B, and accident may occur at the intersection. Thus, this typical configuration of disposing the LiDAR systems in a vehicle may not meet the safety requirements.

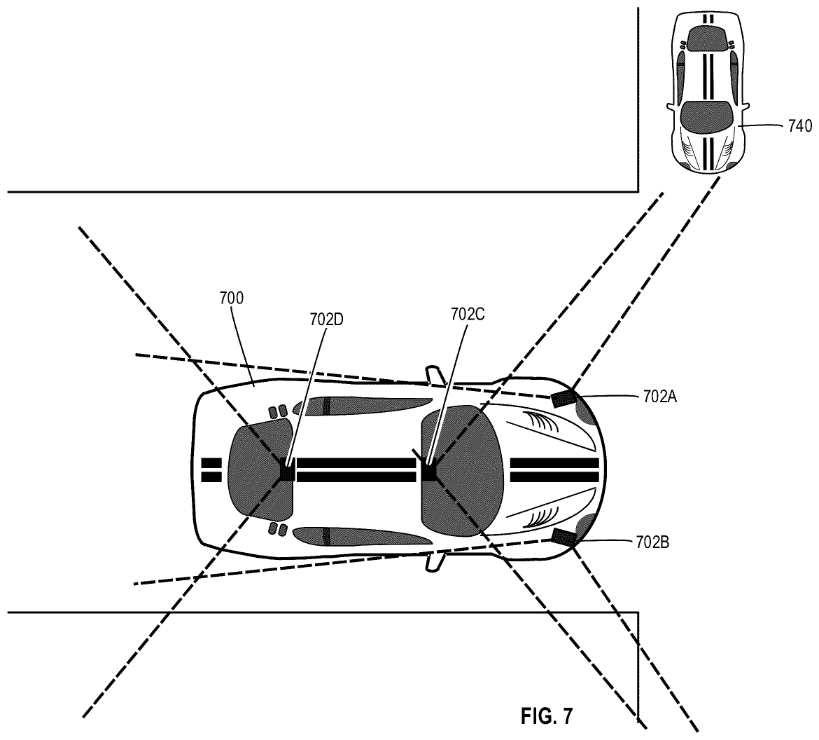

FIG. 7 illustrates an exemplary configuration of multiple LiDAR systems attached to a vehicle 700. As shown in FIG. 7, in this configuration, a LiDAR scanning system 702A can be disposed approximately at the front-left corner of vehicle 700; a LiDAR scanning system 702B can be disposed approximately at the front-right corner of vehicle 700; and a LiDAR scanning system 702C can be disposed approximately at the top portion of a front window-shield of vehicle 700. Further, in some embodiments, one or more additional LiDAR systems can be optionally disposed at other part of vehicle 700. For example, LiDAR system 702D can be disposed approximately at the top portion of a rear window of vehicle 700.

As shown in FIG. 7, the FOV of LiDAR system 702A (indicated by the two lines extending from system 702A) can be configured to encompass a substantial portion of the left side of vehicle 700; the FOV of LiDAR system 702B can be configured to encompass a substantial portion of the right side of vehicle 700; and the FOV of LiDAR system 702C can be configured to encompass a substantial front portion of a front side of vehicle 700. The LiDAR systems 702A-C can be configured such that the FOVs of the multiple LiDAR systems 702A-C overlap with each other and do not leave a gap. In this configuration, for example, a vehicle 740 that approaches the intersection can be detected by at least one of LiDAR system 702A or 702C. As a result, the objects in the surrounding environment of vehicle 700 can be properly detected and potential blind spot can be eliminated to reduce or eliminate the likelihood of collision.

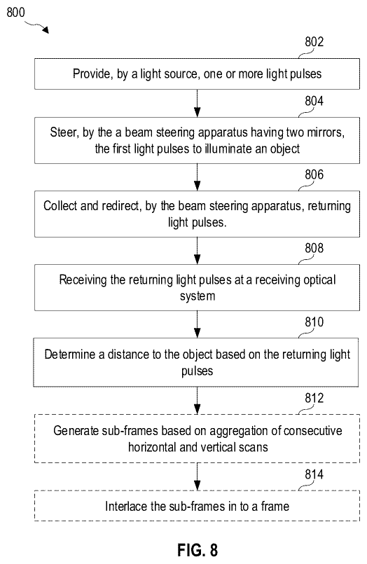

FIG. 8 illustrates an exemplary flow chart 800 for a method of determining time of flight of one or more light pulses for generating a 3D image using a LiDAR scanning system (e.g., system 100 depicted in FIG. 1). With reference to FIG. 8, at block 802, one or more light pulses (e.g., short laser light pulses having a pulse width of about 0.01 nanosecond to 5 nanoseconds or light pulses having a pulse width of 5 nanoseconds to 30 nanoseconds or longer) can be generated from a light source of the LiDAR scanning system. At block 804, a beam steering apparatus can steer or scan the one or more light pulses across the field-of-view in both horizontal and vertical directions. The beam steering apparatus can include two mirrors (e.g., two rotatable mirrors, one rotatable mirror and one oscillation mirror, or one rotatable mirror and one Glavo mirror). The steered one or more light pulses, or a portion thereof, illuminate an object and are scattered or reflected in one or more directions. In some embodiments, a portion of the scattered or reflected light pulses can return to the LiDAR scanning system and reach a collection aperture of the LiDAR scanning system.

At block 806, the one or more returning light pulses can be collected and/or redirected by the beam steering apparatus toward a receiving optical system. At block 808, the one or more redirected returning light pulses can be received at the receiving optical system including, for example, a converging lens and one or more light detectors. At block 810, a distance to the object can be determined based on the returning light pulses. For example, the one or more light detectors convert photons of the redirected returning light pulses that reach the light detectors to one or more electrical signals. The one or more output electrical signals generated by the light detector can be amplified using an amplification circuit or device by a predetermined factor. The amplified one or more electrical signals can be sampled and converted to a digital value at a predetermined sampling rate. In some embodiments, the digitized signal data can be collected within a time period of the expected maximum time-of-flight (ToF) corresponding to the farthest object in the field-of-view. The digitized signal data can be analyzed to determine the ToF of one or more returning light pulses, and determine the distance from the LiDAR scanning system to the reflection or scattering points of the objects.

In some embodiments, at optional block 812, a microcontroller can generate one or more sub-frames based on aggregation of the distances to one or more objects across successive or consecutive horizontal and vertical scans. At optional block 814, the microcontroller can interlace the one or more sub-frames to form a frame with higher resolution.

It is understood that the specific order or hierarchy of blocks in the processes and/or flowcharts disclosed is an illustration of exemplary approaches. Based upon design preferences, it is understood that the specific order or hierarchy of blocks in the processes and/or flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed under 35 U.S.C. § 112(f) unless the element is expressly recited using the phrase “means for.”

1-26. (canceled)

27. A light detection and ranging (LiDAR) system for use with a vehicle, comprising:
a transmitter comprising:
a plurality of semiconductor based light emitters configured to generate light energy, wherein the transmitter is configured to direct the generated light energy along a plurality of different angles, the combination of the plurality of different angles forming at least a part of a vertical angle range and a horizontal angle range of a field-of-view (FOV) of the LiDAR system;
a receiver configured to receive light energy reflected from an object within the FOV of the LiDAR system;
a first mirror and a second mirror, wherein the first mirror is configured to redirect light energy passing between the transmitter and the second mirror, and to redirect light energy passing between the second mirror and the receiver.

28. The LiDAR system of claim 27, wherein at least one of the first mirror or the second mirror is configured to move about a respective axis that does not overlap with a respective normal axis of the first mirror or the second mirror.

29. The LiDAR system of claim 27, wherein the first mirror is a rotatable mirror or an oscillation mirror.

30. The LiDAR system of claim 27, wherein the second mirror is a rotatable mirror or an oscillation mirror.

31. The LiDAR system of claim 27, wherein the first mirror is configured to rotate or oscillate about a first axis at a first rate, and wherein the second mirror is configured to rotate or oscillate about a second axis at a second rate.

32. The LiDAR system of claim 31, wherein the first axis and the normal axis of the first mirror form a first angle, and wherein the second axis and the normal axis of the second mirror form a second angle, the first angle being different from the second angle.

33. The LiDAR system of claim 32, wherein both the first angle and the second angle are greater than 0 degrees and no greater than 90 degrees.

34. The LiDAR system of claim 31, wherein the first rate and the second rate are the same.

35. The LiDAR system of claim 31, wherein the first rate and the second rate are different.

36. The LiDAR system of claim 27, wherein the transmitter is configured to generate light energy at a frequency in accordance with one or more scanning density requirements associated with one or more scanning directions.

37. The LiDAR system of claim 27, wherein the transmitter is configured to direct the generated light energy to the first mirror at a direction determined based on scanning range requirements in one or both of horizontal and vertical directions.

38. The LiDAR system of claim 27, wherein the plurality of semiconductor based light emitters comprises at least one of a diode laser, a diode pump solid state laser, or a fiber coupled diode laser.

39. The LiDAR system of claim 27, further comprising:
a power controller comprising a plurality of power switches, the generated light energy comprising a plurality of light pulses, wherein the plurality of power switches comprises circuitry of a first power switch and circuitry of a second power switch, the first power switch and the second power switch are controllable to select respective different power levels for at least two respective consecutive light pulses of the plurality of light pulses.

40. The LiDAR system of claim 39, wherein the power controller is configured to provide electrical power to the transmitter based on one or more attributes associated with an object disposed in the FOV.

41. The LiDAR system of claim 39, wherein the power controller further comprises:
a voltage divider circuit configured to generate a plurality of discrete voltage levels, wherein the plurality of power switches are configured to facilitate selection of one of the plurality of discrete voltage levels.

42. The LiDAR system of claim 27, further comprising a power delivery circuit configured to, prior to delivering electrical power to the transmitter, select a level of the electrical power deliverable to the transmitter based on prior received optical power, the prior received optical power being optical power of the redirected returning light energy previously received by the receiver.

43. The LiDAR system of claim 42, further comprising a feedback or feedforward circuit configured to provide the optical power of the redirected returning light energy previously received by the receiver to the power delivery circuit.

44. The LiDAR system of claim 42, wherein the power delivery circuit comprises:
a charge storage device configured to store electrical charges corresponding to the level of the electrical power deliverable to the transmitter;
a charge releasing device configured to:
receive a trigger signal; and
in response to the trigger signal, deliver the stored electrical charges to the transmitter.

45. The LiDAR system of claim 27, wherein the receiver comprises a plurality of light detector elements, and wherein a quantity of the plurality of semiconductor based light emitters and a quantity of the plurality of light detector elements are different.

46. The LiDAR system of claim 27, wherein the receiver comprises a plurality of light detector elements, each light detector element of the plurality of light detector elements is configured to receive reflected light energy formed based on a corresponding semiconductor based light emitter of the plurality of semiconductor based light emitters.

47. The LiDAR system of claim 46, wherein the plurality of light detector elements are arranged in a pattern having a same shape as a shape of a pattern in which the plurality of semiconductor based light emitters are arranged.

48. The LiDAR system of claim 27, wherein at least one of the plurality of semiconductor based light emitters is configured to direct light energy independently from other light emitters.

49. The LiDAR system of claim 27, wherein the plurality of semiconductor based light emitters forms a cross shape.

50. The LiDAR system of claim 27, wherein the plurality of semiconductor based light emitters form a rectangular-shaped array.

51. The LiDAR system of claim 27, wherein at least two of the plurality of semiconductor based light emitters are configured to generate light energy having different polarizations.

52. The LiDAR system of claim 27, wherein the transmitter is configured to direct the generated light energy along the plurality of different angles such that the light energy travels in a plurality of light emission paths, each light emission path of the plurality of light emission paths being associated with a semiconductor based light emitter of the plurality of semiconductor based light emitters.

53. The LiDAR system of claim 52, wherein the plurality of light emission paths are aligned such that a fixed angle exists between any two immediately adjacent light emission paths.

54. The LiDAR system of claim 27, further comprising a microcontroller configured to:
generate one or more sub-frames based on aggregation of distances to one or more objects across successive or consecutive horizontal and vertical scans; and
interlace the one or more sub-frames to form a frame with higher resolution.

55. A vehicle comprising a plurality of light detection and ranging (LiDAR) devices, wherein at least one of the plurality of LiDAR devices comprises:
a transmitter comprising:
a plurality of semiconductor based light emitters configured to generate light energy, wherein the transmitter is configured to direct the generated light energy along a plurality of different angles, the combination of the plurality of different angles forming at least a part of a vertical angle range and a horizontal angle range of a field-of-view (FOV) of the each LiDAR device;
a receiver configured to receive light energy reflected from an object within the FOV of the each LiDAR device;
a first mirror and a second mirror, wherein the first mirror is configured to redirect light energy passing between the transmitter and the second mirror, and to redirect light energy passing between the second mirror and the receiver.

56. The vehicle of claim 55, wherein the FOVs of the plurality of LiDAR devices overlap with each other.
